(19) United States
(12) Patent Application Publication
(10) Pub. No.: US 2017/0337629 A1
(43) Pub. Date: Nov. 23, 2017

(54) SYSTEMS AND METHODS FOR ENABLING DOCUMENT REQUIREMENT TRAVERSAL IN RESTRICTED ZONES

(71) Applicant: Bank of America Corporation, Charlotte, NC (US)

(72) Inventors: Pranav Parekh, Hong Kong (HK); Bhupen Velani, Hong Kong (HK); Daniel R. Stanton, Sacramento, CA (US)

(21) Appl. No.: 15/159,945

(22) Filed: May 20, 2016

(51) Int. Cl. G06Q 40/04

(52) U.S. Cl. CPC G06Q 40/04

(57) ABSTRACT

Certain embodiments relate to an article of manufacture for determining whether to traverse, in a restricted zone, a requirement for paper documents. A method for using the article of manufacture may include a receiver that receives electronic documentation relating to a transmission and a transmitter that transmits the electronic documentation for review. The receiver may also receive a determination as to whether the documentation is sufficient to support a transaction associated with the transmission. When the documentation is sufficient to support a transaction associated with the transmission, a processor may flag a prefix of the transmission such that a downstream processor may discern from the flag that the transmission is associated with qualifying electronic documentation.

### FIELD OF THE INVENTION

This invention relates to restricted geographic zones or jurisdictions (hereinafter, collectively, “zones.”) Specifically, this invention relates to enabling document requirement traversal in restricted zones.

### BACKGROUND OF THE INVENTION

Certain software packages are unable to offer, and confirm, online, real-time, information relating to certain transmissions in certain restricted jurisdictions. The restrictions in these jurisdictions typically relate to protective restrictions that ensure that extra-jurisdictional forces and/or stimuli do not upset intra-jurisdictional equilibriums.

For example, certain software packages, such as treasury system packages, are unable to offer electronic confirmation of onshore foreign exchange (“FX”) rates for certain restricted zones in Asia. Accordingly, in these zones, clients may only be offered an indicative FX rate prior to consummating a transaction. Supporting documents, as required in many of these zones, must be delivered to local operations groups often through non-electronic media. Such delivery is typically manually intensive. The requirements of such delivery may also vary greatly from entity to entity, and even from location to location within an entity.

Furthermore, these processes and/or requirements are less “client-friendly.” In addition, such processes and/or requirements may reduce a financial entity's competitiveness vis-à-vis entities that can offer electronic confirmation and/or documentation upload as part of an integrated solution.

Understandably, such restrictions, while important for insulating a restricted zone from extra-jurisdictional forces such as extra-jurisdictional currency transactions, may unnecessarily restrict non-disruptive transactions and/or non-disruptive trade.

It would be desirable to modify consolidation logic and connection logic between software applications, such as treasury applications and trade processing applications, that operate in the restricted zones.

It would be further desirable to integrate an onshore FX rate determination in such restricted zones, trade booking, routing, documentation workflow, payment processing, accounting reconciliation and/or client reporting.

### SUMMARY OF THE DISCLOSURE

Certain embodiments may allow clients to quote and confirm onshore FX rates in restricted zones. Furthermore, some embodiments may allow a foreign trade to be booked back to onshore entities.

Certain embodiments may include a hybrid apparatus/process. The hybrid apparatus/process may include a processor and a receiver. The receiver may operate, under the direction of the processor, to receive documentation associated with a transmission.

The hybrid apparatus/process may further include a transmitter. The transmitter may be configured to transmit, under the direction of the processor, the documentation for review. Following the transmission of the documentation, the receiver may be further configured to receive a determination as to whether the documentation is sufficient to support a transaction associated with the transmission.

When the documentation is sufficient to support a transaction associated with the transmission, the processor may be further configured to flag a prefix of the transmission such that a downstream processor may discern from the flag that the transmission is associated with qualifying electronic documentation.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a conventional hybrid process-apparatus;

FIG. 2 shows another conventional hybrid process-apparatus;

FIG. 3 shows a first hybrid process-apparatus according to certain embodiments;

FIG. 4 shows another hybrid process-apparatus according to certain embodiments; and

FIG. 5 shows yet another hybrid process-apparatus according to certain embodiments.

### DETAILED DESCRIPTION OF THE DISCLOSURE

A hybrid apparatus/process according to certain embodiments may include a processor and a transmitter. The hybrid apparatus/process may also include a receiver.

The receiver may operate, under the direction of the processor, to receive documentation associated with a transmission.

The transmitter may be configured to transmit, under the direction of the processor, the documentation for review.

Following the transmission of the documentation, the receiver may be further configured to receive a determination as to whether the documentation is sufficient to support a transaction associated with the transmission. When the receiver receives a determination that the documentation is sufficient to support the transaction, the processor may be further configured to flag the transmission as enabled for processing independent further human intervention. Such processing may include confirming an onshore FX rate for use in the transaction.

In certain embodiments, the processor may be further configured to flag a prefix of the transmission. The processor may flag the prefix of the transmission such that a downstream processor may discern from the flag whether the transmission is a first type of transmission or a second type of transmission.

In some embodiments, the processor may be further configured to flag a prefix of the transmission such that a downstream processor may discern from the flag whether the transmission is a treasury-type transmission or an import-type transmission.

In certain embodiments, the processor may be configured to flag a prefix of the transmission such that a downstream processor may discern from the flag whether the transmission qualifies for straight-through-processing.

The processor may be further configured to flag a prefix of the transmission such that a downstream processor may discern from the flag whether the transmission is associated with qualifying electronic documentation and, if the transmission is associated with qualifying electronic documentation, then the processor qualifies the transmission for straight-through-processing.

As mentioned above, the processor may be configured to flag the prefix of the transmission such that processor may confirm an onshore FX (foreign exchange) rate in a restricted jurisdiction.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

As set forth above, there are two aspects to hybrid processes/apparatus associated with the invention. The first aspect relates to treasury payments—i.e., paying for employees or other assets outside the country. Such treasury payments may also include receipt of payments for goods exported outside the country. Treasury payments may require an onshore conversion of funds from a foreign currency to a local currency.

The second aspect relates to payments for imported goods. This second aspect typically requires an onshore conversion of a local currency to a foreign currency in order to pay for the imported goods.

It should be noted that, although treasury payments—i.e., the first aspect described above—represent about 60% of the total value of the hybrid processes described above, treasury payments represent about 90% of the total number of payments (because of the relatively high number of treasury payments that are low value.)

Under certain conditions, transactions and/or transmissions involving treasury payments or payments for imported goods may impact a jurisdiction's currency. As such, certain jurisdictions have implemented restrictive procedures to regulate implementation of currency conversion at onshore rates. Such restrictive procedures support the review and/or regulation of such transactions and/or transmissions. One manner of regulating requires that the onshore participants provide hard, typically paper, copies of documentation necessary to support such transactions and/or transmissions. Another manner of regulating such transactions and/or transmissions involves requiring personal attention by pre-determined individuals.

A solution according to the embodiments described herein may preferably allow clients located in restricted zones to quote and/or confirm onshore FX rates in a treasury payment system. Moreover, such embodiments may preferably enable users to book import trade(s) back to onshore entities at onshore FX rates, even though the trades occurred outside the restricted jurisdictions.

In addition, some embodiments may enable modification of PSH. For the purposes of this application, PSH may be understood to be an internal middleware which enables synchronization between different applications of payments and FX in order to validate onshore currency cut off and branch operating hours. For the purposes of this application, onshore currency cut off may be understood as follows: every currency can only be circulated based on opening or clearing as well as internal bank cut offs which depend on liquidity and operational criteria. These two, together with the understanding that defined branch operating hours may be one typical operational criteria, may be characterized as a currency cut off—i.e., the last possible time that a currency can be traded.

In addition, some embodiments may preferably allow clients to complete and/or upload necessary supporting documentation for each FX payment. These, and/or other embodiments, may preferably support an interface for an operations groups to review, approve or reject such transactions. Certain embodiments may preferably notify clients upon, inter alia, document status change. In certain embodiments, clients may be enabled to repair and or reload supporting documentation as needed.

In sum, the challenges that the embodiments are designed to respond to include the requirement of physical document submission to an entity involved with onshore confirmation of the onshore FX rate in a restricted jurisdiction. Furthermore, the embodiments may also be designed to respond to demands on the availability of authorized signatories. The solutions provided by the embodiments may preferably include enabling submission, and approval, of documents online. Such submissions may preferably occur at times and places that are convenient with respect to the restricted zones. Such solutions may also provide online availability of documents for a pre-determined period—e.g., two years—or some other suitable period. Such availability abrogates conventional requirements of physical document warehousing and archival for queries.

In addition, certain embodiments may flag certain transmissions such that the transmissions are easily discernible by downstream processors. Such flags may enable a downstream processor to differentiate between import payments and treasury payments. Such flags may enable a downstream processor to differentiate between a transmission that requires hard, paper, documentation and genuine human attention and a transmission that does not require hard documentation and human participation—i.e., one that may be executed using straight-through-process (“STP”) absent human participation or at least with a relatively lower degree of human participation.

Embodiments are also designed to mitigate risk of delay associated with document transmission and risk of loss of documents in transit.

Embodiments may also be designed to upgrade the conventional requirement to record and confirm an onshore FX rate by phone. Instead, embodiments may preferably enable a user to approve and confirm an onshore FX rate using electronic communication. Embodiments may also enable electronic confirmation with an associated onshore FX rate in a restricted zone.

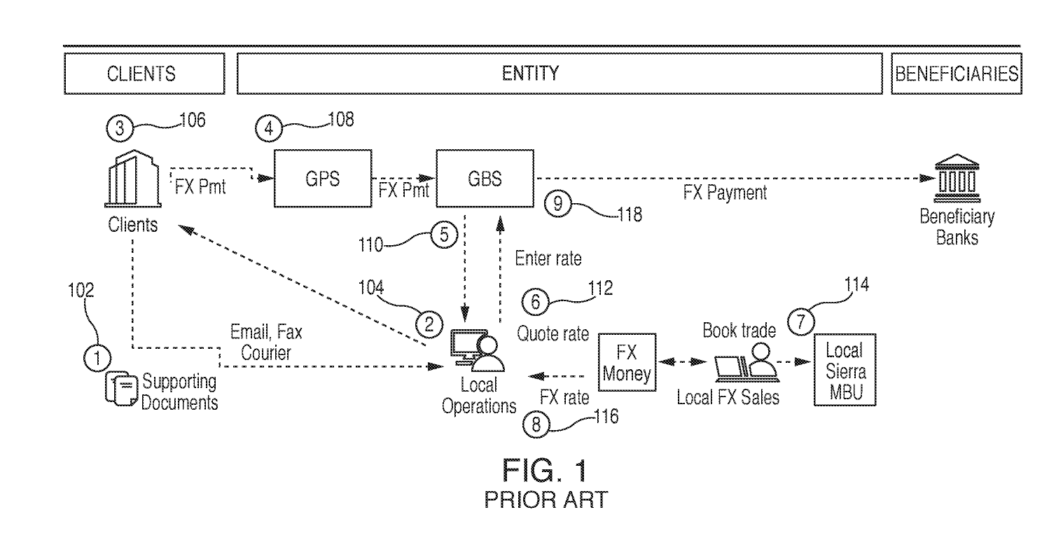

FIG. 1 shows a conventional hybrid process-apparatus. At 102, step 1 shows a client sending supporting documents to an operations level group. Such a transmission may typically be executed via e-mail, fax and/or courier. Such documents may typically be required to enable completion of a treasury payment or other relevant payment.

At 104, step 2 shows that the operations level group may inspect supporting documents. Upon confirmation from the operations level group that the supporting documents are in order, step 3 shows, at 106, that a client may initiate a FX payment via Global Banking System (“GBS”) software, or other suitable software that is capable of fixing an indicative FX rate in a restricted zone.

At 108, Global Payment System (“GPS”) validates the FX rate and pushes the transaction to GBS. For the purposes of this application, GBS software may be understood to be treasury payment systems or other systems for facilitating cross-border, or other, transactions. For reasons that follow, at this point of the legacy transaction, the onshore FX rate is only indicative, and cannot be confirmed, until hard documentation is reviewed by a qualified representative.

At 110, the FX rate, and payment, then falls, in certain restricted markets, into an operations repair queue, as shown at step 5. The operations group may then request an onshore FX rate once the supporting documents are found to be in order.

At 112, step 6 shows that, following the confirmation that the documents are in order and onshore the FX rate has been approved by FX money—a foreign exchange desk or other suitable entity within the entity—the onshore FX rate may be entered.

At 114, step 7 shows booking a trade via FX money using the requested FX rate. The trade may be booked at Local Sierra MBU—i.e., an FX application for booking FX rates in the local country—for example, India.

At 116, step 8 shows that FX money is used to return the confirmed, and executed, onshore FX rate to the operations group.

At 118, the operations group releases the payment from the repair queue, populates rates to GBS and executes the FX payment by sending the FX payment to a beneficiary.

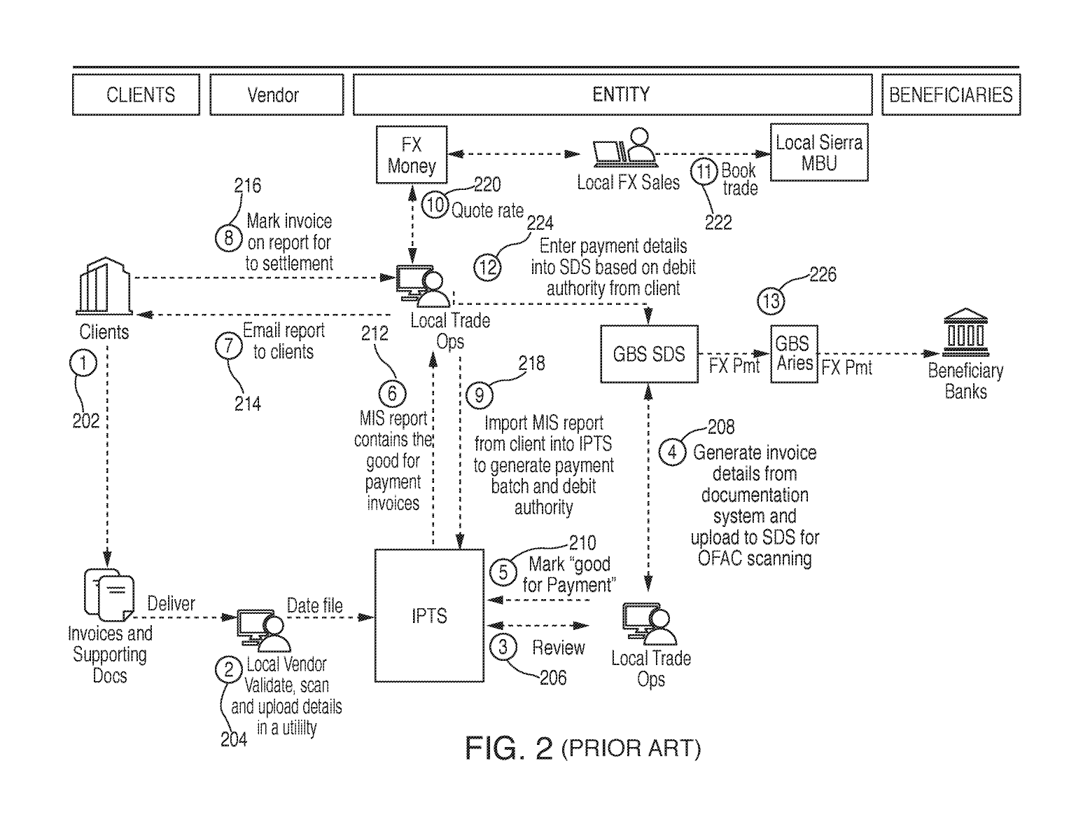

FIG. 2 shows another conventional hybrid process-apparatus. The hybrid process-apparatus in FIG. 2 relates to the conventional state of trade flow execution.

At 202, step 1 shows that clients deliver physical invoices and supporting documentation to a local vendor. The local vendor may be responsible for coordinating document deposit for associated transactions.

At 204, step 2 shows that the local vendor may validate the invoices and supporting documentation. The local vendor may also scan the invoices and/or supporting documentation into a PDF and enter the document details into a utility. This utility preferably generates the invoice file and transmits the invoice file to IPTS.

At 206, step 3 shows that a local trade operations group reviews the invoices. At 208, step 4 shows that the local trade operations group generates invoice details from documentation system and uploads the details for OFAC scanning. OFAC refers to the Office of Foreign Asset Control which may regulate monitoring and/or review documents in restricted zones. At 210, step 5 shows that the local trade operations group may preferably mark the transaction as good for payment.

At 212, step 6 shows that an Management Information System (MIS) report is generated including the “good for payment” invoices. At 214, step 7 shows reporting to client(s). At 216, step 8 shows marking an invoice on the MIS report for settlement. At 218, step 9 shows importing the MIS report from a client into IPTS to generate payment batcha and debit authority. The local operations group is typically responsible for sending the debit authority to a client in order to complete the instructions. At 220, step 10 shows quoting an FX rate for a cross-currency payment. At 222, step 11 shows that local FX sales can preferably book a trade and store the trade in Local Sierra MBU and then preferably return the FX rate at which the trade occurred into FX money.

At 224, the local trade operations group may manually enter the payment details into SDS (an internal system for sanction screening) based on information from the client's debit authority. Clients can typically fund a single payment by debiting multiple accounts. At 226, step 13 shows GBS SDS preferably generates the payment instructions to GBS Aries and subsequently sent to beneficiaries.

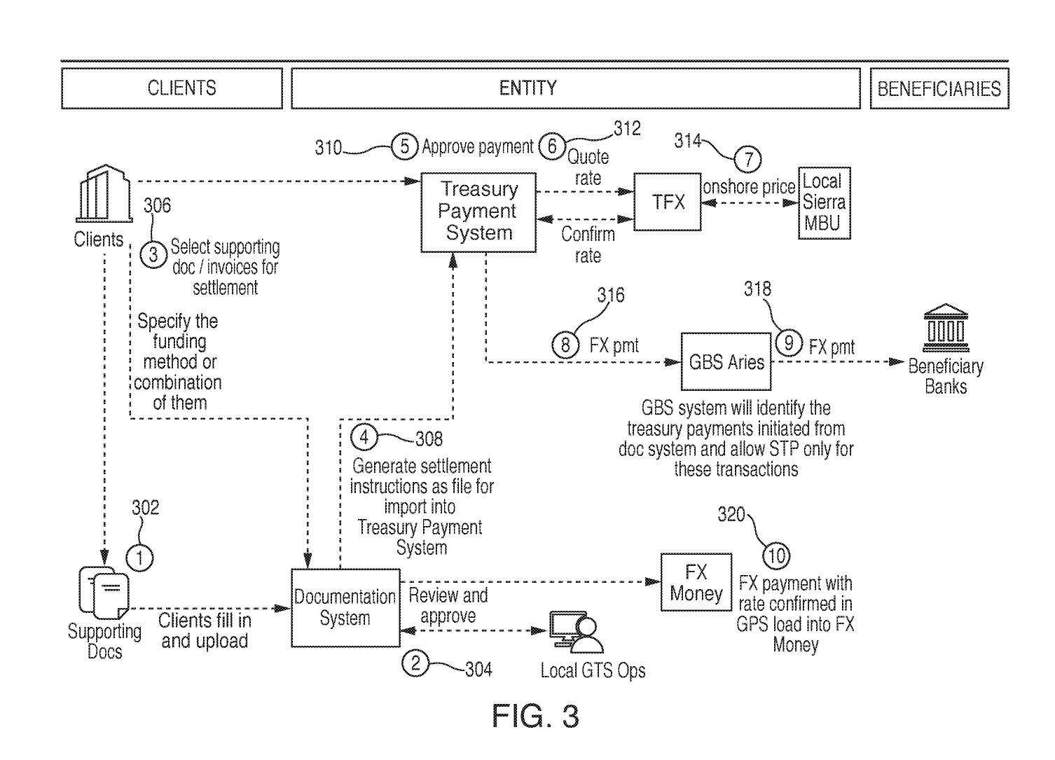

FIG. 3 shows a first hybrid process-apparatus according to certain embodiments. Specifically, FIG. 3 shows target states for a treasury flow according to certain embodiments.

At 302, step 1 shows enabling clients to complete required documents and upload required documents to a documentation system independent external assistance. At 304, step 2 shows that a local operations group may preferably review and approve submitted documentation.

At 306, step 3 shows selecting supporting documentation and/or invoices for use in transaction settlement. Furthermore, step 3 may preferably include specifying the funding method—e.g., online trade, pre-booked trade or foreign currency amount) or combination of funding methods. At 308, step 4 shows generating settlement instructions as a file for import into a treasure payment system. At 310, step 5 shows that the treasury payment system preferably approves, or enables approval of, the payment. At 312, step 6 shows quote an FX rate to TFX—i.e., Transactional FX team. Preferably thereafter, at 314, step 7 shows that TFX may retrieve an onshore price from Local Sierra MBU, and confirm the FX rate to the treasury payment system. At 316, step 8 shows that the GBS Aries system may preferably identify treasury payments initiated from the documentation system and allow straight through processing (“STP”) preferably only for these transactions. At 318, step 9 shows making the payment to beneficiary banks. At 320, step 10 shows making the FX payment using FX Money with the rate confirmed in GPS which is then loaded into FX money.

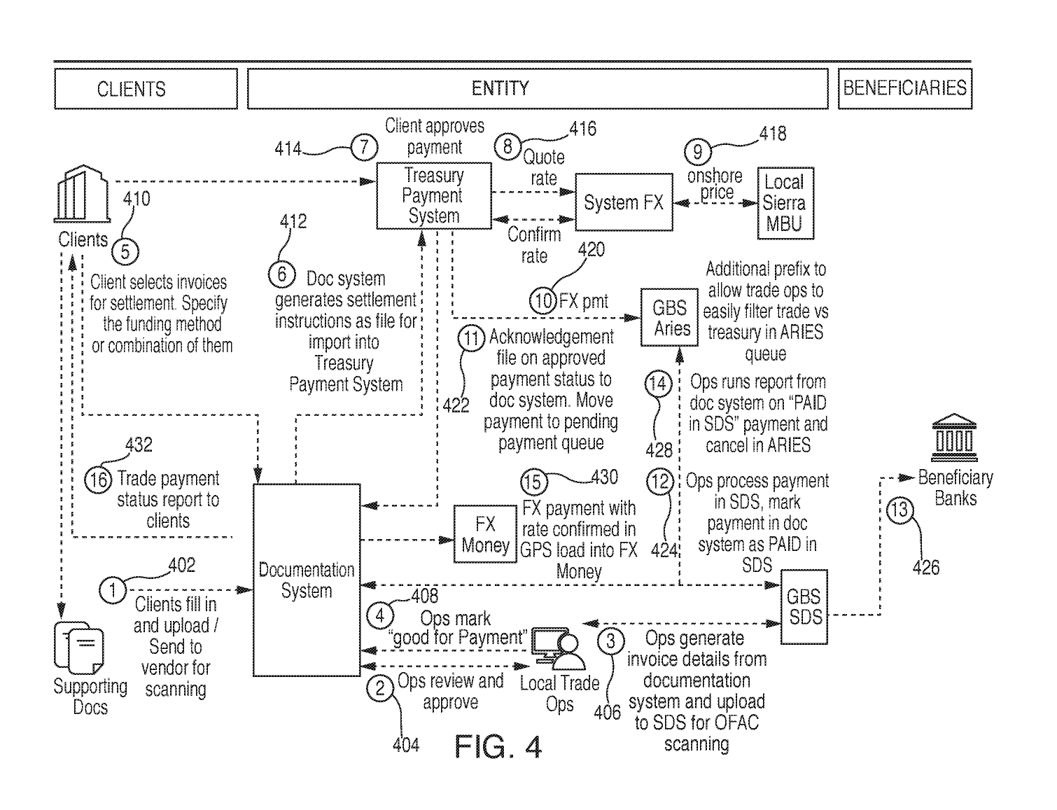

FIG. 4 shows another hybrid process-apparatus according to certain embodiments. Specifically, FIG. 4 is directed to a target state for a non-bulk import payment trade flow. At 402, step 1 shows either clients completing in and uploading documentation to a documentation system according to the invention and/or transmitting such documentation to a vendor for the vendor to complete and/or upload the documentation to a documentation system. At 404, step 2 shows that the local operations group may preferably review and approve the uploaded documentation. In case of any discrepancies in the documents, the local operations group may preferably provide comments and request for additional information from clients.

At 406, step 3 shows that the local operations group preferably generates invoice details from the documentation system and uploads the details to GBS SDS for OFAC scanning. At 408, step 4 shows that the local operations group may, following review and approval of the documentation and the invoice, mark the invoice “good for payment.”

At 410 step 5 shows that the clients can select invoices for settlement and preferably specify the funding method, or combination of funding methods and/or a debit account number. The documentation system may preferably consolidate the invoices into settlement instructions. By consolidating several invoices into one set of settlement instructions, not only does the system provide confirmation of onshore FX rates absent paper documentation, but the system also saves substantial bandwidth associated with the transfer and involvement associated with the paper documentation.

At 412, step 6 shows that the documentation system may generate settlement instructions as a file for import into a treasury payment system. At 414, step 7 shows payment approval. At 416, step 8 shows quoting an FX rate to an FX system and, at 418, step 9 shows returning an onshore price to the FX system. Thereafter the rate is confirmed to the treasury payment system. At 420, step 10 shows transmission of the FX payment feed to the GBS Aries system. This transmission further appends an additional prefix to the payment file in order to allow the operations group to easily differentiate trade from treasury in the payment queue.

At 422, step 11, which may occur preferably substantially simultaneous to step 10, shows transmission to the documentation system of an acknowledgment file. The acknowledgment file preferably includes an approved payment status. This transmission preferably moves the payment to the pending payment queue.

At 424, step 12 shows that the local operations group may process payment in SDS and mark payment in the documentation system as PAID in SDS. At 426, step 13 shows that SDS may send one more payments to beneficiaries.

At 428, step 14 shows that the local operations group may preferably periodically run a report from the documentation system relating to items “PAID in SDS” and cancel the payment from GBS Aries. At 430, step 15 shows that FX payments with rate confirmed in GPS load into FX money. Preferably only for FX payment with rate confirmed online, the documentation system may feed the details to FX money for regulatory reporting purposes. Transactions that do not include a rate confirmed in GPS must follow the current flow as set forth in FIG. 2, and the portion of the specification corresponding thereto. This may include a requirement that the local operations group enters the transaction into FX money manually as part of the FX rate request process. At 432, step 16 shows that the process may further include electronically transmitting a trade payment status report to clients.

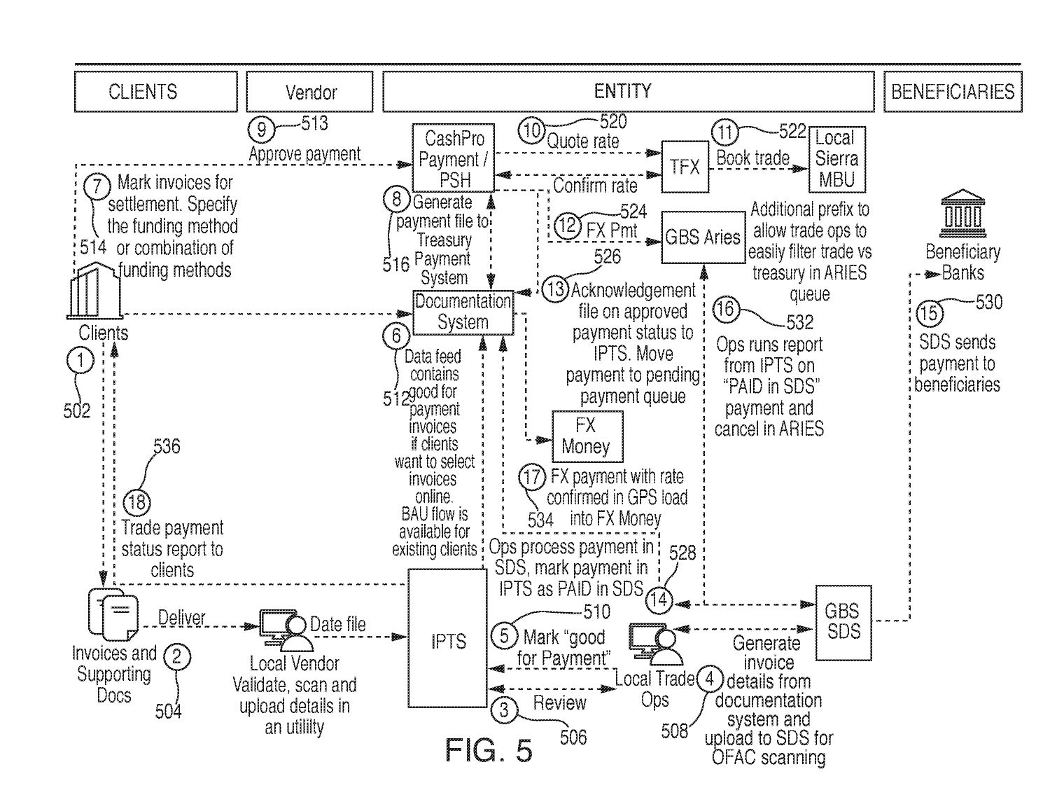

FIG. 5 shows yet another hybrid process-apparatus according to certain embodiments. More specifically, FIG. 5 is directed to a bulk import payment trade flow. At 502, step 1 shows clients delivering physical invoices and supporting documentation to a local vendor. At 504, step 2 shows that the local vendor validates the invoices and supporting documentation, scans the invoices and supporting documentation in order to derive a PDF file, and enters the document details into a document utility. The utility preferably generates the invoice file and transmits the file to IPTS.

At 506, step 3 shows that the local trade operations group preferably reviews the invoice. At 508, step 4 shows that the local trade operations group generates invoice details based on the information from the document system and uploads these details to SDS for OFAC scanning. At 510, step 5 shows that the local trade operations group may preferably mark the invoices as “good for payment.”

At 512, step 6 shows that a data feed that contains good for payment invoices may be implemented if clients want to select processing invoices online. A business as usual (“BAU”) flow is available to for existing clients.

At 514, step 7 shows that a client may mark invoices for settlement and specify a funding method or combination of funding methods. At 516, step 8 shows that the documentation system may preferably generate a payment file for loading into a treasury payment system.

At 518, step 9 shows that a client approver approves payment(s). At 520, step 10 shows that, if clients choose to get a rate online, the treasury payment system may preferably connect to TFX for an FX rate. At 522, step 11 shows that TFX books a trade to Local Sierra MBU. At 524, step 12 shows that an FX payment is made from the treasury payment system to GBS Aries. At 526, step 13 shows that an acknowledgment file on approved payment status is transmitted to IPTS. The payment is then moved to a pending payment queue.

At 528, step 14 shows that the local operations group may preferably process the payment in SDS, and mark payment in IPTS as PAID in SDS. Preferably, the approver will approve the process in SDS and approve the item as paid.

At 530, step 15 shows that SDS may send payment to beneficiaries. At 532, step 16 shows that the local operations group may preferably periodically run a report from the documentation system that contains information a list of “Paid in SDS” payments; and cancel the items from ARIES. The local operations group may then update the ARIES cancellation in the documentation system and subsequently update the status in IPTS.

At 534, step 17 shows that FX payment with rate confirmation in GPS is loaded into FX money. Preferably only for FX payment with rate confirmed online, the documentation system feeds the details to FX money for regulatory reporting purpose. Those without a currency exchange rate confirmed in GPS will follow the BAU where the trade operations group has to manually enter into FX money as part of the FX rate request process. At 536, step 18 shows that trade payment status may preferably be reported to clients.

Thus, methods and apparatus for document requirement traversal in restricted zones have been provided. Persons skilled in the art will appreciate that the present invention can be practiced by other than the described embodiments, which are presented for purposes of illustration rather than of limitation, and that the present invention is limited only by the claims that follow.

What is claimed is:

1. A hybrid apparatus/process comprising:
a processor;
a receiver for receiving, under the direction of the processor, documentation associated with a transmission;
a transmitter;
wherein the transmitter is configured to transmit, under the direction of the processor, the documentation for review;
wherein, following the transmission of the documentation, the receiver is further configured to receive a determination as to whether the documentation is sufficient to support a transaction associated with the transmission, and, when the documentation is sufficient to support a transaction associated with the transmission, the processor is further configured to flag a prefix of the transmission such that a downstream processor may discern from the flag that the transmission is associated with qualifying electronic documentation.

2. The hybrid apparatus/process of claim 1, wherein the processor is further configured to further flag the prefix of the transmission such that a downstream processor may discern from the flag whether the transmission is a first type of transmission or a second type of transmission.

3. The hybrid apparatus/process of claim 1, wherein the processor is further configured to further flag the prefix of the transmission such that a downstream processor may discern from the flag whether the transmission is a treasury type transmission or an import type transmission.

4. The hybrid apparatus/process of claim 1, wherein the processor is further configured to flag the prefix of the transmission such that a downstream processor may discern from the flag whether the transmission qualifies for straight-through-processing.

5. The hybrid apparatus/process of claim 1, wherein the processor is further configured to flag the prefix of the transmission such that processor may confirm an onshore FX (“Foreign Exchange”) rate in a restricted jurisdiction.

6. A hybrid apparatus/process comprising:
a processor;
a receiver for receiving, under the direction of the processor, documentation associated with a transmission;
a transmitter;
wherein the transmitter is configured to transmit, under the direction of the processor, the documentation for review;
wherein, following the transmission of the documentation, the receiver is further configured to receive a determination as to whether the documentation is sufficient to support a transaction associated with the transmission;
when the receiver receives a determination that the documentation is sufficient to support the transaction, the processor is further configured to flag the transmission as enabled for processing independent further human intervention.

7. The hybrid apparatus/process of claim 6, wherein, when the receiver receives a determination that the documentation is sufficient to support the transmission, the processor is further configured to flag a prefix of the transmission.

8. The hybrid apparatus/process of claim 7, wherein, the processor is further configured to flag a prefix of the transmission such that a downstream processor may discern from the flag whether the transmission is first type of transmission or second type of transmission.

9. The hybrid apparatus/process of claim 6, wherein, the processor is further configured to flag a prefix of the transmission such that a downstream processor may discern from the flag whether the transmission is a treasury type transmission or an import type transmission.

10. The hybrid apparatus/process of claim 6, wherein, the processor is further configured to flag a prefix of the transmission such that a downstream processor may discern from the flag whether the transmission qualifies for straight-through-processing.

11. The hybrid apparatus/process of claim 6 wherein the processor is further configured to flag a prefix of the transmission such that a downstream processor may discern from the flag whether the transmission is associated with qualifying electronic documentation and, if the transmission is associated with qualifying electronic documentation, then the processor qualifies the transmission for straight-through-processing.

12. The hybrid apparatus/process of claim 6, wherein the processor is further configured to flag the prefix of the transmission such that processor may confirm an onshore Foreign Exchange (“FX”) rate in a restricted jurisdiction.

13. An article of manufacture comprising a non-transitory computer usable medium having computer readable program code embodied therein, the code when executed by one or more processors for configuring a computer to execute a method to determine whether to traverse, in a restricted zone, a requirement for paper documents, the method comprising:
using a receiver to receive, under the direction of a processor, electronic documentation relating to a transmission;
using a transmitter to transmit, under the direction of a processor, the electronic documentation for review;
using a receiver to receive, under the direction of a processor, a determination as to whether the documentation is sufficient to support a transaction associated with the transmission, and, when the documentation is sufficient to support a transaction associated with the transmission, using the processor to flag a prefix of the transmission such that a downstream processor may discern from the flag that the transmission is associated with qualifying electronic documentation and, thereby, obviate a requirement for providing an onshore rate for currency conversion, said related related to paper documentation.

14. The article of manufacture of claim 13, further comprising using the processor to further flag the prefix of the transmission such that a downstream processor may discern from the flag whether the transmission is a first type of transmission or a second type of transmission.

15. The article of manufacture of claim 13, further comprising using the processor to further flab the prefix of the transmission such that a downstream processor may discern from the further flagged prefix whether the transmission is a treasury-type transmission or an import-type transmission.

16. The article of manufacture of claim 13, further comprising using the processor to flag the prefix of the transmission such that a downstream processor may discern from the flag whether the transmission qualifies for straight-through-processing.

17. The article of manufacture of claim 13, further comprising using the processor to further flag the prefix of the transmission such that the processor may be enabled to confirm an onshore Foreign Exchange (“FX”) rate in a restricted jurisdiction.
